(19) United States
(12) Patent Application Publication
(10) Pub. No.: US 2019/0095860 A1
(43) Pub. Date: Mar. 28, 2019

(54) DELIVERY SERVICE OPERATING METHOD AND DEVICE, AND INTEGRATED DELIVERY SERVICE SYSTEM

(71) Applicant: CAFE24 CORP. (Specialty Contractor Financial Bldg., Sindaebangdong), Seoul (KR)

(72) Inventor: Jae Suk LEE, Seoul (KR)

(21) Appl. No.: 15/745,995

(22) PCT Filed: Aug. 30, 2016
(86) PCT No.: PCT/KR2016/009643

§ 371 Date: Jan. 19, 2018

(30) Foreign Application Priority Data
Jun. 14, 2016 (KR) 10-2016-0074044

(51) Int. Cl. G06Q 10/08; G06Q 10/06; G06F 16/9038

(52) U.S. Cl. CPC G06Q 10/0834; G06F 16/9038; G06Q 10/063116; G06Q 10/0832

(57) ABSTRACT

A delivery service operating method and device, and an integrated delivery service system are disclosed. The delivery service operating method can: acquire, from a shopping mall website, information on a destination to which a product is to be delivered; extract information, on a plurality of delivery people, corresponding to the information on the destination; display, on a user terminal, the information on the plurality of delivery people by using the shopping mall website, and when any one of the plurality of delivery people is selected, transmit, to each of a delivery company server corresponding to the selected delivery person and a local distribution base server corresponding to the destination, a product delivery request such that the selected delivery person delivers the product to the destination. Therefore, the delivery person desired by a user can deliver the product.

### TECHNICAL FIELD

The present invention relates to a method and apparatus for managing a parcel delivery service and an integrated parcel delivery service system and, more particularly, to a method and apparatus for managing a parcel delivery service and a base system therefor, wherein an article can be easily delivered from an article seller, such as an online shopping mall, to a consumer.

### BACKGROUND ART

In general, in online shopping, a shopping mall website is displayed in the terminal of a user through wired or wireless Internet. When a consumer views an article, selects a desired article in the website, and pays for the article, the paid article is delivered to the consumer through a delivery company. Such online shopping is convenient in that although a consumer does not directly visit a store, the consumer can easily purchase a desired article at home and the article is delivered to a destination through a parcel delivery service. Accordingly, the online shopping market has been expanded to the extent that it can equal the offline market.

In general, the reputation of an online shopping mall inevitably has a great influence on the success of the online shopping mall. The reputation of an online shopping mall may be determined by various and complex factors, such as the price, product display, convenience of shopping and a level of service satisfaction.

For example, a consumer spends much time to purchase an article of good quality at the lowest price. However, although a consumer has purchased a desired article of good quality at the lowest price in a specific online shopping mall, if dissatisfaction is generated in a delivery process, the consumer does not consider that he or she did good shopping. That is, a parcel delivery service responsible for the delivery process of an article may be considered to be an important factor that determines a level of satisfaction of shopping.

In accordance with “Parcel delivery service use condition” published by the Korea Chamber of Commerce and Industry in 2013, factors that influence the level of satisfaction of a parcel delivery service were “delivery speed and accuracy (42.9%)”, “delivery state (16.6%), “processing attitude when damage or a loss is generated (13.8%), “level of kindness of delivery person (11.4%), etc.

In this case, “delivery speed and accuracy” is a factor determined by the system of a shopping mall and a logistic system constructed by a delivery service company, but “delivery state”, “processing attitude when damage or a loss is generated”, “level of kindness”, and so on may be said to be factors that are determined by a delivery person who finally comes into contact with a consumer or that may have a great influence on a delivery person.

As described above, although a delivery service is an important service directly associated with a consumer's satisfaction, a delivery service company that has made a contract with a seller and a delivery person designated by the delivery service company are unilaterally responsible for article delivery without a consumer's rights to select them in the delivery service in a conventional online shopping process. Accordingly, there is an urgent need for the development of a new system capable of improving the level of satisfaction of the parcel delivery service.

### DISCLOSURE

### Technical Problem

The present invention is for solving such a problem and an object of the present invention is to provide a method and apparatus for managing a parcel delivery service, which enable an article to be easily delivered from a shopping mall, etc. to a consumer based on the active selection of a delivery person by the consumer, and an integrated parcel delivery service system that is a base therefor.

### Technical Solution

In order to accomplish the object, in an aspect, the present invention provides a method of managing a parcel delivery service. The method of managing a parcel delivery service is a method of managing a parcel delivery service performed by a parcel delivery service operation server, and includes the steps of obtaining information of a destination to which an article is to be delivered from a shopping mall website; extracting information of a plurality of delivery persons corresponding to the information of the destination; displaying the information of the plurality of delivery persons in a user terminal using the shopping mall website; and sending an article delivery request to a delivery company server corresponding to a selected delivery person and a local logistics depot server corresponding to the destination so that the selected delivery person delivers the article to the destination when any one of the plurality of delivery persons is selected.

When the user terminal accesses the shopping mall website and inputs the information of the destination by which the article is to be received in a purchase process for the purchase of the article, the shopping mall website may send the input information of the destination to the parcel delivery service operation server. The step of obtaining the information of the destination may include the step of receiving the information of the destination received from the shopping mall website.

The step of extracting the information of the plurality of delivery persons may include the steps of questioning a plurality of delivery company servers associated with the plurality of delivery persons about the information of the plurality of delivery persons corresponding to the information of the destination; and receiving the information of the plurality of delivery persons corresponding to the information of the destination from the plurality of delivery company servers.

The method of managing a parcel delivery service may further include the step of constructing a delivery person information database in which information of a plurality of delivery persons corresponding to information of a plurality of destinations is stored and managed based on interlocking with a plurality of delivery company servers. The step of extracting the information of the plurality of delivery persons may include the step of extracting the information of the plurality of delivery persons corresponding to the information of the destination from the delivery person information database.

The step of displaying the information in the user terminal may include the steps of transferring the information of the plurality of delivery persons to the shopping mall website; and controlling the shopping mall website so that a delivery person selection user interface including the information of the plurality of delivery persons is displayed in the user terminal in a purchase process for the purchase of the article.

The delivery person selection user interface may include at least one of ID information of each of the delivery persons, evaluation information of each of the delivery persons and delivery company information corresponding to each of the delivery persons, and may provide a function which enables the user terminal to select any one of the plurality of delivery persons. The article delivery request may include article information related to the article; the information of the destination; information of the selected delivery person; information of the delivery company corresponding to the selected delivery person; and information of a local logistics depot corresponding to the destination.

The method of managing a parcel delivery service may further include the steps of displaying an evaluation input user interface in which an evaluation of the delivery person who has sent the article can be input using the shopping mall website in the user terminal; and storing input evaluation information in a database in association with the information of the delivery person when the evaluation information about the delivery person is received through the evaluation input user interface.

The method of managing a parcel delivery service may further include the step of making a transportation contract for a parcel delivery service with the shopping mall website, a plurality of delivery company servers and the local logistics depot server.

Meanwhile, in order to accomplish the object of the present invention, in another aspect, the present invention provides an apparatus for managing a parcel delivery service. The apparatus for managing a parcel delivery service may include a delivery information acquisition unit obtaining information of a destination to which an article is to be delivered from a shopping mall website; an information extraction unit extracting information of a plurality of delivery persons corresponding to the information of the destination; an information display unit displaying the information of the plurality of delivery persons in a user terminal using the shopping mall website; and an article delivery request unit sending an article delivery request to a delivery company server corresponding to a selected delivery person and a local logistics depot server corresponding to the destination so that the selected delivery person delivers the article to the destination when any one of the plurality of delivery persons is selected.

When the user terminal accesses the shopping mall website and inputs the information of the destination by which the article is to be received in a purchase process for the purchase of the article, the shopping mall website may send the input information of the destination to the parcel delivery service operation server. In response thereto, the delivery information acquisition unit may receive the information of the destination received from the shopping mall website.

The information extraction unit may question a plurality of delivery company servers associated with the plurality of delivery persons about the information of the plurality of delivery persons corresponding to the information of the destination and receive the information of the plurality of delivery persons corresponding to the information of the destination from the plurality of delivery company servers.

The apparatus for managing a parcel delivery service may further include a database server unit constructing a delivery person information database in which information of a plurality of delivery persons corresponding to information of a plurality of destinations is stored and managed based on interlocking with a plurality of delivery company servers. The information extraction unit may extract the information of the plurality of delivery persons corresponding to the information of the destination from the delivery person information database.

The information display unit may transfer the information of the plurality of delivery persons to the shopping mall website and control the shopping mall website so that a delivery person selection user interface including the information of the plurality of delivery persons is displayed in the user terminal in a purchase process for the purchase of the article.

The delivery person selection user interface may include at least one of ID information of each of the delivery persons, evaluation information of each of the delivery persons and delivery company information corresponding to each of the delivery persons, and provides a function which enables the user terminal to select any one of the plurality of delivery persons. The article delivery request may include article information related to the article, the information of the destination, information of the selected delivery person, information of the delivery company corresponding to the selected delivery person, and information of a local logistics depot corresponding to the destination.

The information display unit may display an evaluation input user interface in which the evaluation of the delivery person who has sent the article can be input using the shopping mall website in the user terminal. When evaluation information about the delivery person is received through the evaluation input user interface, the information display unit may store the input evaluation information in a database in association with the information of the delivery person.

The apparatus for managing a parcel delivery service may further include a contract conclusion unit making a transportation contract for a parcel delivery service with the shopping mall website, a plurality of delivery company servers and the local logistics depot server.

Meanwhile, in order to accomplish the object, in yet another aspect, the present invention may provide an integrated parcel delivery service system. The integrated parcel delivery service system may include a shopping mall website in which an accessed user terminal is callable of purchasing an article; a plurality of delivery company servers; a plurality of local logistics depot servers; and a parcel delivery service operation server operating in conjunction with the shopping mall website and the plurality of delivery company servers, obtaining information of a destination to which the article is to be delivered from the shopping mall website, extracting information of a plurality of delivery persons corresponding to the information of the destination, displaying the information of the plurality of delivery persons in the user terminal using the shopping mall website, and sending an article delivery request to a delivery company server corresponding to a selected delivery person and a local logistics depot server corresponding to the destination so that the selected delivery person delivers the article to the destination when any one of the plurality of delivery persons is selected.

When the user terminal accesses the shopping mall website and inputs the information of the destination by which the article is to be received in a purchase process for the purchase of the article, the shopping mall website may send the input information of the destination to the parcel delivery service operation server.

The parcel delivery service operation server may question a plurality of delivery company servers associated with the plurality of delivery persons about the information of the plurality of delivery persons corresponding to the information of the destination, and may receive the information of the plurality of delivery persons corresponding to the information of the destination from the plurality of delivery company servers.

The parcel delivery service operation server may construct a delivery person information database in which information of a plurality of delivery persons corresponding to information of a plurality of destinations is stored and managed based on interlocking with a plurality of delivery company servers, and may extract the information of the plurality of delivery persons corresponding to the information of the destination from the delivery person information database.

The parcel delivery service operation server may transfer the information of the plurality of delivery persons to the shopping mall website and control the shopping mall website so that a delivery person selection user interface including the information of the plurality of delivery persons is displayed in the user terminal in a purchase process for the purchase of the article.

The parcel delivery service operation server may display an evaluation input user interface in which the evaluation of the delivery person who has sent the article can be input using the shopping mall website in the user terminal, and may store input evaluation information in a database in association with the information of the delivery person when the evaluation information about the delivery person is received through the evaluation input user interface.

Meanwhile, in yet another aspect, the present invention provides a method of processing article delivery. The method of processing article delivery may include the steps of inputting information of a destination to which an article is to be delivered in a purchase process for purchasing the article selected by a user terminal; sending the input information of the destination to a parcel delivery service operation server; receiving information of the plurality of delivery persons corresponding to the information of the destination from the parcel delivery service operation server; displaying a delivery person selection user interface in which the received information of the plurality of delivery persons is included and any one of the piece of information of the plurality of delivery persons is capable of being selected in the user terminal; and sending an article delivery request including information of a selected delivery person and article delivery information necessary to deliver the article to the parcel delivery service operation server when the delivery person is selected by the user terminal based on the delivery person selection user interface.

In yet another aspect, the present invention provides an apparatus for processing article delivery. The apparatus for processing article delivery may include a first processing unit which inputs information of a destination to which an article is to be delivered in a purchase process for purchasing the article selected by a user terminal and sends the input information of the destination to a parcel delivery service operation server; and a second processing unit which receives information of the plurality of delivery persons corresponding to the information of the destination from the parcel delivery service operation server, displays a delivery person selection user interface in which the received information of the plurality of delivery persons is included and any one of the piece of information of the plurality of delivery persons is capable of being selected in the user terminal, and sends an article delivery request including information of a selected delivery person and article delivery information necessary to deliver the article to the parcel delivery service operation server when the delivery person is selected by the user terminal based on the delivery person selection user interface.

In yet another aspect, the present invention provides an integrated parcel delivery service method. The integrated parcel delivery service method may include the steps of inputting, by a shopping mall website, information of a destination to which an article is to be delivered in a purchase process for the purchase of an article selected by a user terminal; sending the input information of the destination to a parcel delivery service operation server; extracting, by the parcel delivery service operation server, information of a plurality of delivery persons corresponding to the information of the destination transmitted by the shopping mall website and sending the information of the plurality of delivery persons to the shopping mall website; displaying, by the shopping mall website, a delivery person selection user interface which includes the information of the plurality of delivery persons received from the parcel delivery service operation server and in which any one of the pieces of information of the plurality of delivery persons can be selected in a user terminal; sending information of a selected delivery person and article delivery information necessary for the delivery of the article to the parcel delivery service operation server when the delivery person is selected by the user terminal based on the delivery person selection user interface; and sending, by the parcel delivery service operation server, an article delivery request that enables the selected delivery person to deliver the article to the destination to a delivery company server corresponding to the information of the selected delivery person and a local logistics depot server corresponding to the destination.

### Advantageous Effects

As described above, in accordance with the present invention, information of a destination can be obtained when information for the purchase of an article is input, information about delivery persons who are responsible for the corresponding destination can be provided, and a user can select a delivery person based on the integrated parcel delivery service system.

Accordingly, from the point of view of a user, a service that is safe and has a high level of satisfaction can be provided because the user can designate a delivery person who is usually acquainted or kind and has a good service and can receive an article. A shopping mall can fundamentally prevent the reputation of the shopping mall from becoming poor due to unsatisfactory delivery.

### DESCRIPTION OF DRAWINGS

FIG. 1 is a block diagram for illustrating the configuration of an integrated parcel delivery service system according to a preferred embodiment of the present invention.

FIG. 2 is a block diagram showing the configuration of a parcel delivery service operation server according to a preferred embodiment of the present invention.

FIG. 3 shows a flowchart for illustrating an operation flow of the integrated parcel delivery service system according to a preferred embodiment of the present invention.

FIG. 4 is an exemplary diagram illustratively showing a destination input user interface for inputting destination information.

FIG. 5 is an exemplary diagram illustratively showing a delivery person selection user interface displayed in an article purchase process.

FIG. 6 shows a flowchart for illustrating a flow of the transmission of an article corresponding to the operation flow shown in FIG. 3.

FIG. 7 is an exemplary diagram illustratively showing an evaluation input user interface displayed in a user terminal.

### MODE FOR INVENTION

Hereinafter, preferred embodiments of the present invention are described in more detail with reference to the accompanying drawings. In describing the present invention, in order to facilitate general understanding, the same reference numerals are used to denote the same elements throughout the drawings, and a redundant description of the same elements is omitted.

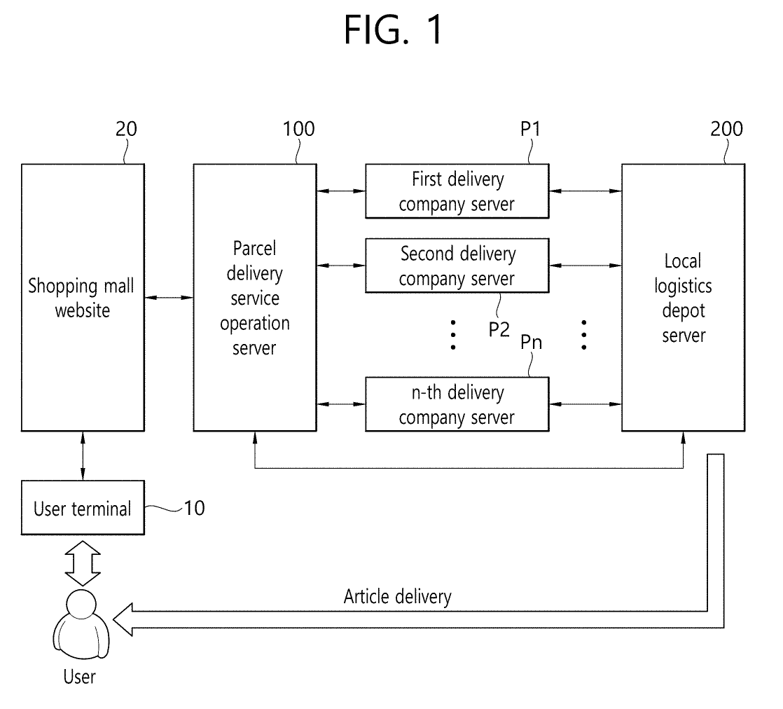

FIG. 1 is a block diagram for illustrating the configuration of an integrated parcel delivery service system according to a preferred embodiment of the present invention.

As shown in FIG. 1, a parcel delivery service operation server 100 may operate in conjunction with a shopping mall website 20, a plurality of delivery company servers P1, . . . , Pn and a local logistics depot server 200 over a communication network. Each of the parcel delivery service operation server 100, the shopping mall website 20, the delivery company servers P1, . . . , Pn and the local logistics depot server 200 may be implemented by at least one server-level network computer terminal in hardware. Each computer terminal may include memory which stores digital data, for example, programs and instructions, a processor which executes digital programs stored in the memory, a communication processor, an information input/output unit, storage for storing data, and so on.

The shopping mall website 20 may mean an online shopping mall system which provides a shopping mall in which an article can be purchased online on a web. That is, the shopping mall website 20 displays articles in a user terminal 10 connected thereto and provides an online shopping mall in which a desired article can be selected and purchased. The user terminal 10 may mean a terminal capable of accessing the Internet on a wired or wireless basis, such as the PC, notepad, smartphone, etc. of a user.

A plurality of (for example, n (n is an integer of 2 or more)) the delivery company servers P1, . . . , Pn may mean a plurality of servers of delivery company for the delivery of articles. Each of the delivery company servers may place an order to delivery persons belonging to the corresponding delivery company. For example, each delivery company server may receive an article delivery request, including parcel delivery article delivery information and delivery person information, from the parcel delivery service operation server 100, and may transfer an order to delivery persons so that the delivery is performed according to the received article delivery information. For example, the delivery company server may place an order to specific delivery persons so that an article is primarily delivered from a shopping mall to a local logistics depot corresponding to a destination to which the article will be delivered through the distribution terminal of a corresponding delivery company based on article delivery information, and may transfer the order to a delivery person selected according to the present invention so that the selected delivery person delivers the article from the local logistics depot to the destination.

For example, the delivery company server may be the server of a delivery company, such as “LOGEN Delivery Co. Ltd.”, “LOTTE Delivery Co. Ltd.” or “CJ Delivery Corporation.” After an article transferred to the delivery company server is delivered to a “LOGEN Delivery Co. Ltd. distribution Terminal”, a “LOTTE Delivery Co. Ltd. distribution Terminal” or a “CJ Delivery Corporation distribution Terminal”, it is delivered to the local logistics depot of a destination designated in an article delivery request and delivered to the destination by a selected delivery person.

The local logistics depot server 200 is an apparatus which manages a local logistics depot, and may make a contract with the parcel delivery service operation server 100 and operate in conjunction therewith. The local logistics depot may be a base which is provided in each specific area and integrally collects the articles of a plurality of delivery companies. The delivery persons of each delivery company who are responsible for the delivery of a corresponding area have only to visit a local logistics depot without a need to visit their company's logistics depots, to find out temporarily stored article and to deliver them to destinations.

Such a local logistics depot server 200 may receive an article delivery request from the parcel delivery service operation server 100, may monitor whether articles corresponding to the article delivery request are normally delivered by a delivery company based on the received article delivery request, and may monitor that delivery persons pick up the transferred articles in order to deliver them to destinations. The service operator of the parcel delivery service operation server 100 may manage and operate the local logistics depot server 200.

The parcel delivery service operation server 100 can manage a parcel delivery service by making a transportation contract with the shopping mall website 20, the plurality of delivery company servers P1, . . . , Pn and the local logistics depot server 200 and playing the role of an intermediary between the shopping mall website 20 and the plurality of delivery company servers P1, . . . , Pn. The parcel delivery service operation server 100 can manage an improved parcel delivery service which enables a corresponding delivery person to deliver an article to a user by enabling the user who has purchased the article to actively select the delivery person who will deliver the article and transferring an article delivery request to a delivery company server corresponding to the selected delivery person.

Hereinafter, a process of managing the parcel delivery service managed by the parcel delivery service operation server 100, the configuration of the parcel delivery service operation server 100, and the configuration of the parcel delivery service system realized by them are described in detail.

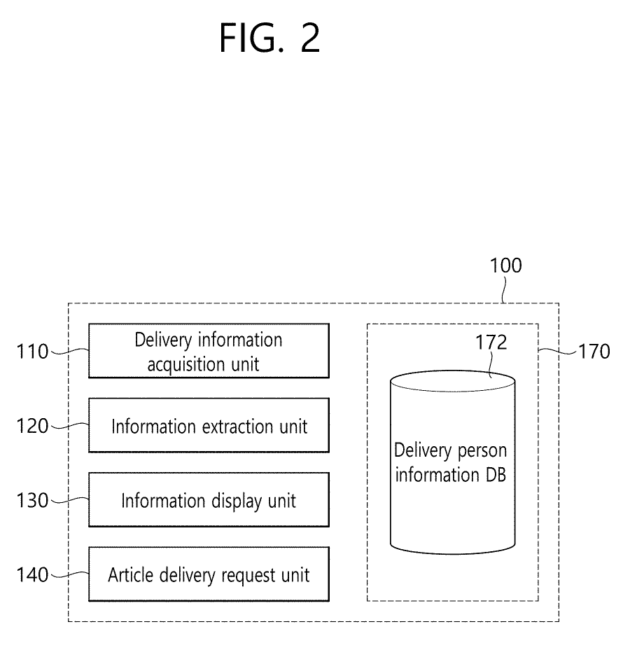

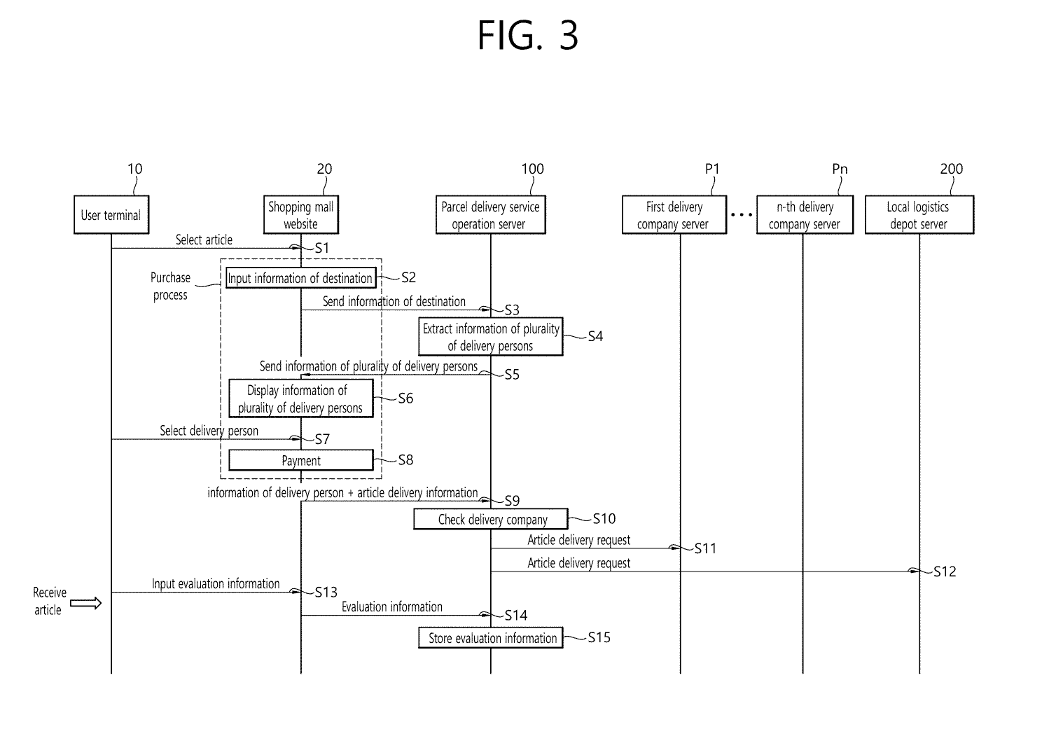

FIG. 2 is a block diagram showing the configuration of the parcel delivery service operation server 100 according to a preferred embodiment of the present invention. FIG. 3 shows a flowchart for illustrating an operation flow of the integrated parcel delivery service system according to a preferred embodiment of the present invention.

Referring to FIGS. 1 to 3, after accessing a communication network using the user terminal 10, a user may access the shopping mall website 20. The shopping mall website 20 may provide various user interfaces and services for an online shopping mall based on a web to the accessed user terminal 10.

The user terminal 10 may select an article to be purchased while doing the shopping in the shopping mall website 20 (step: S1). Accordingly, the shopping mall website 20 may perform a purchase process capable of purchasing the article selected by the user terminal 10.

For example, a user interface for information input, payment, etc. for an article purchase may be displayed in the user terminal 10, information may be received, and the payment may be performed.

In such a purchase process, the shopping mall website 20 may display a destination input user interface in which information of a destination to which the article will be delivered in the user terminal 10.

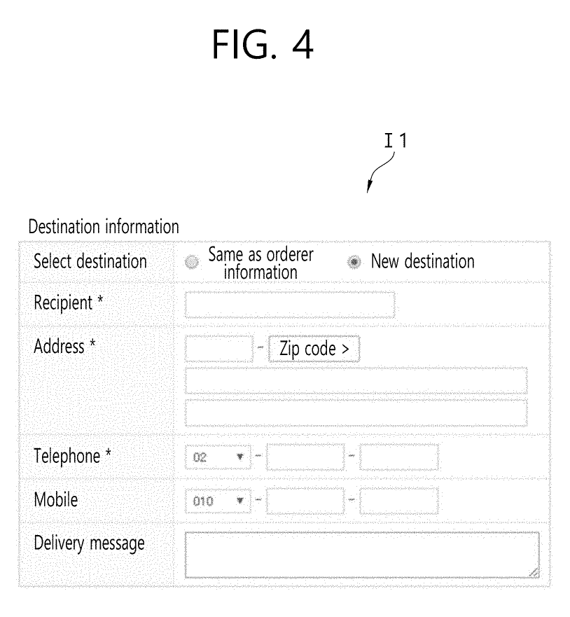

FIG. 4 is an exemplary diagram illustratively showing the destination input user interface for inputting destination information. As shown in FIG. 4, the destination input user interface I1 displays a destination input box in which the address to which an article will be delivered can be entered. A user may input information of the destination to which an article will be delivered using such a destination input box (step: S2). For example, the user may input information of a destination, such as “1111, Yeoksam 1-dong, Gangnam-gu, Seoul, Korea.”

When the information of the destination is received, the shopping mall website 20 sends the input information of the destination to the parcel delivery service operation server 100 (step: S3). Accordingly, the parcel delivery service operation server 100 may obtain the information of the destination to which the article will be transmitted. The acquisition of the information of the destination may be performed by the delivery information acquisition unit 110 of the parcel delivery service operation server 100.

The parcel delivery service operation server 100 that has obtained the information of the destination to which the article will be transmitted may extract information of a plurality of delivery persons corresponding to the obtained information of the destination (step: S4). In this process, the parcel delivery service operation server 100 may extract the delivery persons of each delivery company who are responsible for the delivery of an area corresponding to the information of the destination. That is, information of a plurality of delivery persons corresponding to the destination is extracted from a plurality of delivery companies.

For example, if the obtained destination is “1111, Yeoksam 1-dong, Gangnam-gu, Seoul, Korea”, the parcel delivery service operation server 100 may extract information of the delivery persons of LOGEN Delivery Corporation that is a first delivery company, information of the delivery persons of LOTTE Delivery Co. Ltd. that is a second delivery company, and information of the delivery persons of CJ Delivery Corporation that is a third delivery company, who are responsible for the delivery of “1111, Yeoksam 1-dong.” This is an example in which n is 3. It is assumed that the first delivery company uses the first delivery company server P1, the second delivery company uses the second delivery company server P2, and the third delivery company uses a third delivery company server (not shown).

The extraction of the information of the plurality of delivery persons may be performed by the information extraction unit 120 of the parcel delivery service operation server 100. A process of extracting the information of the plurality of delivery persons may be performed by questioning the plurality of delivery company servers P1, . . . , Pn in real time or using a previously constructed database.

For example, the information extraction unit 120 may extract the information of the plurality of delivery persons corresponding to the information of the destination by questioning the plurality of delivery company servers P1, . . . , Pn associated with a plurality of delivery persons about information of a plurality of delivery persons corresponding to the information of the destination and receiving the information of the plurality of delivery persons corresponding to the information of the destination from the plurality of delivery company servers P1, . . . , Pn.

The parcel delivery service operation server 100 may include a database server unit 170. The database server unit 170 previously constructs a delivery person information DB 172 in which information of a plurality of delivery persons corresponding to information of a plurality of destinations are stored and managed based interlocking with the plurality of delivery company servers P1, . . . , Pn. In this case, the information extraction unit 120 may extract the information of the plurality of delivery persons corresponding to the information of the destination from the delivery person information DB 172.

As described above, the parcel delivery service operation server 100 that has extracted the information of the plurality of delivery persons displays the extracted information of the plurality of delivery persons in the user terminal 10 using the shopping mall website 20.

Specifically, the parcel delivery service operation server 100 sends the information of the plurality of delivery persons to the shopping mall website 20 (step: S5) and requests the shopping mall website 20 to display the information of the plurality of delivery persons in the user terminal 10 (step: S6). Such a process may be performed by the information display unit 130 of the parcel delivery service operation server 100. The information display unit 130 communicates with the shopping mall website 20, and may perform control so that a specific webpage is inserted into or a specific webpage is displayed in the shopping mall website 20 based on the transmission of information and a command for control to the shopping mall website 20.

For example, the parcel delivery service operation server 100 may control the online shopping mall website 20 so that it displays a delivery person selection user interface including the information of the plurality of delivery persons in the user terminal 10 during a purchase process for the purchase of the article.

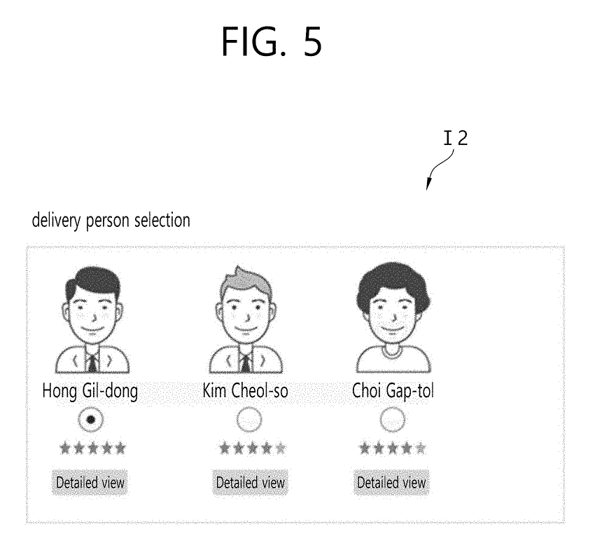

FIG. 5 is an exemplary diagram illustratively showing the delivery person selection user interface displayed in the article purchase process.

As shown in FIG. 5, the delivery person selection user interface 12 displayed in the user terminal 10 displays a plurality of delivery persons and is equipped with a button by which a user can select a desired delivery person. ID information of each delivery person, evaluation information of each delivery person, other detailed information, etc. may be displayed in the delivery person selection user interface 12.

The ID information of a delivery person may be, for example, the name of the delivery person, a photo of the delivery person, etc. The evaluation information of a delivery person may be at least one of evaluation information that users who previously received articles evaluated the delivery person and evaluation information that a user previously evaluated the corresponding delivery person. The evaluation information may be displayed in a form, such as a score, a graph or star rating, for example. The detailed information may include information of a delivery company to which a delivery person belongs, evaluation information of the delivery company, the history of the delivery person who previously delivered an article to a user who has purchased an article, the sex of the delivery person, and so on.

The user terminal 10 may select any one delivery person in the displayed information of the plurality of delivery persons (step: S7). Next, the shopping mall website 20 may perform a payment process (step: S8). When the payment is completed, the shopping mall website 20 may send information of the selected delivery person and article delivery information necessary for article delivery to the parcel delivery service operation server 100 (step: S9). The article delivery information may include article information, the information of the destination, information of the user, etc.

The parcel delivery service operation server 100 that has received the article delivery information may determine a delivery company corresponding to information of the selected delivery person (step: S10), and may send the article delivery request to the delivery company server of the corresponding delivery company (step: S11).

For example, assuming that the parcel delivery service operation server 100 has analyzed the information of the selected delivery person and the user has selected information of a delivery person who belongs to LOGEN Corporation, that is, the first delivery company, the article delivery request may be transmitted to the delivery company server of LOGEN Corporation that is the first delivery company server P1. The article delivery request may include the information of the selected delivery person, the article information related to the article that is delivered, the information of the destination, information of the delivery company corresponding to the selected delivery person, the information of a local logistics depot corresponding to the destination, the information of the user, and so on. The determination of the delivery company and the generation and transmission of the article delivery request may be performed by the article delivery request unit 140 of the parcel delivery service operation server 100.

Furthermore, the article delivery request unit 140 of the parcel delivery service operation server 100 may send the article delivery request to the local logistics depot server 200 corresponding to the destination (step: S12). That is, in accordance with a preferred embodiment of the present invention, the parcel delivery service operation server 100 sends the article delivery request to the local logistics depot server 200 corresponding to the destination to which the article will be delivered along with the transfer of the article delivery request to the delivery company server to which the selected delivery person belongs, for example the first delivery company server P1. As described above, the local logistics depot server 200 is a server which manages a local logistics depot, that is, an integrated common logistics depot in which a plurality of delivery companies integrally collects articles delivered to an area corresponding to a specific range (for example, dong, myeon or distance).

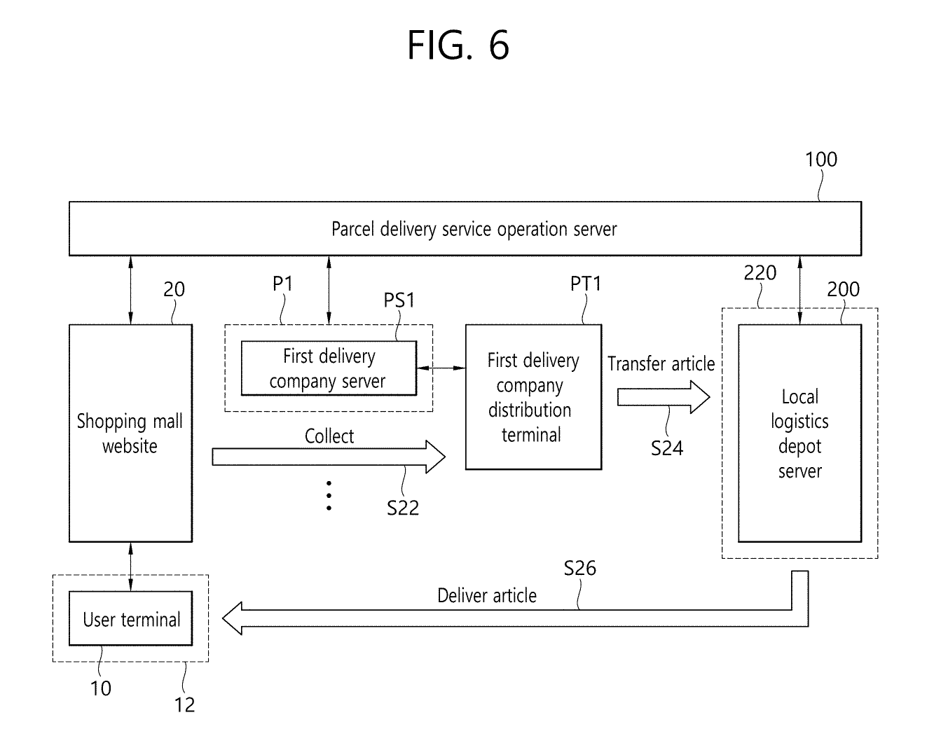

When the article delivery request is delivered to the first delivery company server P1 and the local logistics depot server 200, article delivery may be performed. FIG. 6 shows a flowchart for illustrating a flow of the transmission of an article corresponding to the operation flow shown in FIG. 3.

Referring to FIG. 6, the first delivery company server P1 of the first delivery company P1 that has received the article delivery request transfers an article delivery order to the server of a first delivery company distribution terminal PT1 based on the article delivery request. The article is transferred from a seller of the shopping mall website 20 to the first delivery company distribution terminal PT1 and collected in response to the order (step: S22). Next, the article is transferred from the first delivery company distribution terminal PT1 to a local logistics depot 220 (step: S24). Meanwhile, the local logistics depot server 200 that has received the article delivery request monitors whether the article corresponding to the article delivery request [symbol] has been correctly transferred to the local logistics depot 220. If the article is delivered to the local logistics depot 220, the delivery person who is a delivery person belonging to the first delivery company P1 and has been selected by the user terminal 10 may pick up the article from the local logistics depot 220 and deliver the article to the user 12 (step: S26).

Meanwhile, the user 12 who has received the article may input evaluation information of the delivery person and the delivery service, such as the level of kindness of the delivery person and the level of service satisfaction of the delivery person, to the shopping mall website 20 using the user terminal 10 (step: S13).

For example, the information display unit 130 of the parcel delivery service operation system may display an evaluation input user interface in which the evaluation of the delivery person who has sent the article can be input in the user terminal 10 using the shopping mall website 20.

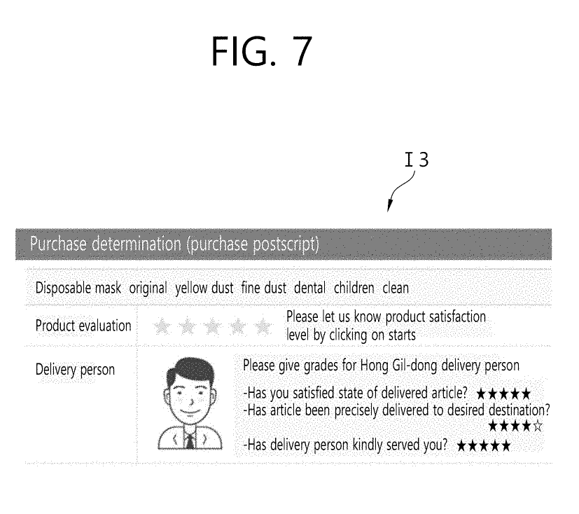

FIG. 7 is an exemplary diagram illustratively showing an evaluation input user interface displayed in the user terminal 10.

As shown in FIG. 7, the shopping mall website 20 may display the evaluation input user interface 13 in the user terminal 10 in response to a request from the parcel delivery service operation system. For example, the shopping mall website 20 may display an input box or input button in which the evaluation of a delivery person can be input in an input box for evaluating the level of satisfaction of an article in the step of determining the purchase of the article. The evaluation of the delivery person may include a plurality of items, for example, the state of a delivered article, whether an article has been precisely transferred to a required destination, and the level of kindness of a delivery person.

When the evaluation information about the delivery person is received through the evaluation input user interface 13, the parcel delivery service operation server 100 may receive the input evaluation information from the shopping mall website 20 (step: S14) and store the received evaluation information in the delivery person information DB 172 in association with the information of the corresponding delivery person (step: S15).

Meanwhile, the parcel delivery service operation server 100 may calculate a satisfaction degree score for each delivery person based on the stored evaluation information and store the calculated satisfaction degree score in the delivery person information DB 172. The satisfaction degree score for each delivery person may be an average of the scores of a plurality of evaluation items, for example, evaluation items, such as the state of a delivered article, whether an article has been precisely delivered to a desired destination, and the level of kindness of a delivery person or may be calculated by applying weight to at least some items.

Furthermore, the satisfaction degree score for each delivery person may be an average of the evaluation scores of users who received articles from the delivery person. The satisfaction degree score for each delivery person may be an average of evaluation scores which have been input by users after the users received articles from a corresponding delivery person.

The parcel delivery service operation server 100 may calculate the level of satisfaction of a delivery company based on the satisfaction degree scores of delivery persons belonging to each delivery company, and may store the calculated level of satisfaction in the delivery person information DB 172. Furthermore, the parcel delivery service operation server 100 may store information, indicating that a delivery person who delivers an article has delivered the article of a user, in the delivery person information DB 172 in association with an evaluation score.

As described above, pieces of information computed and stored in various ways by the delivery person information DB 172 may be displayed in the delivery person selection user interface displayed when a delivery person is selected along with information of the delivery person in order for another user or a current user to purchase an article next time.

As described above, in accordance with a preferred embodiment of the present invention, information of a destination by which an article will be received can be obtained when information for the purchase of an article is input, information of delivery persons who are responsible for the corresponding destination can be provided, and a user can actively select a delivery person.

Accordingly, instead of a conventional technology in which delivery is unilaterally performed by a specific delivery person according to a contract between a seller and a delivery company, from the point of view of a user, a service that is safe and has a high level of satisfaction can be provided because the user can designate a delivery person who is usually acquainted or kind and has a good service and can receive an article. A shopping mall can fundamentally prevent the reputation of the shopping mall from becoming poor due to unsatisfactory delivery.

Although the preferred embodiments of the present invention have been described above, those skilled in the art will appreciate that the present invention may be modified and changed in various ways without departing from the technological contents and scope of the present invention written in the appended claims. Accordingly, a change of the future embodiments of the present invention will not depart from the technology of the present invention.

1. A method of managing a parcel delivery service performed by a parcel delivery service operation server, the method comprising steps of:
obtaining information of a destination to which an article is to be delivered from a shopping mall website;
extracting information of a plurality of delivery persons corresponding to the information of the destination;
displaying the information of the plurality of delivery persons in a user terminal using the shopping mall website; and
sending an article delivery request to a delivery company server corresponding to a selected delivery person and a local logistics depot server corresponding to the destination so that the selected delivery person delivers the article to the destination when any one of the plurality of delivery persons is selected.

2. The method of claim 1, wherein:
when the user terminal accesses the shopping mall website and inputs the information of the destination by which the article is to be received in a purchase process for the purchase of the article, the shopping mall website sends the input information of the destination to the parcel delivery service operation server, and
the step of obtaining the information of the destination comprises a step of receiving the information of the destination received from the shopping mall website.

3. The method of claim 1, wherein the step of extracting the information of the plurality of delivery persons comprises steps of:
questioning a plurality of delivery company servers associated with the plurality of delivery persons about the information of the plurality of delivery persons corresponding to the information of the destination; and
receiving the information of the plurality of delivery persons corresponding to the information of the destination from the plurality of delivery company servers.

4. The method of claim 1, further comprising a step of constructing a delivery person information database in which information of a plurality of delivery persons corresponding to information of a plurality of destinations is stored and managed based on interlocking with a plurality of delivery company servers,
wherein the step of extracting the information of the plurality of delivery persons comprises a step of extracting the information of the plurality of delivery persons corresponding to the information of the destination from the delivery person information database.

5. The method of claim 1, wherein the step of displaying the information in the user terminal comprises steps of:
transferring the information of the plurality of delivery persons to the shopping mall website; and
controlling the shopping mall website so that a delivery person selection user interface comprising the information of the plurality of delivery persons is displayed in the user terminal in a purchase process for the purchase of the article.

6. The method of claim 5, wherein the delivery person selection user interface comprises at least one of ID information of each of the delivery persons, evaluation information of each of the delivery persons and delivery company information corresponding to each of the delivery persons, and provides a function which enables the user terminal to select any one of the plurality of delivery persons.

7. The method of claim 1, wherein the article delivery request comprises:
article information related to the article;
the information of the destination;
information of the selected delivery person;
information of the delivery company corresponding to the selected delivery person; and
information of a local logistics depot corresponding to the destination.

8. The method of claim 1, further comprising steps of:
displaying an evaluation input user interface in which an evaluation of the delivery person who has sent the article is capable of being input using the shopping mall website in the user terminal; and
storing input evaluation information in a database in association with the information of the delivery person when the evaluation information about the delivery person is received through the evaluation input user interface.

9. The method of claim 1, further comprising a step of making a transportation contract for a parcel delivery service with the shopping mall website, a plurality of delivery company servers and the local logistics depot server.

10. An apparatus for managing a parcel delivery service, comprising:
a delivery information acquisition unit obtaining information of a destination to which an article is to be delivered from a shopping mall website;
an information extraction unit extracting information of a plurality of delivery persons corresponding to the information of the destination;
an information display unit displaying the information of the plurality of delivery persons in a user terminal using the shopping mall website; and
an article delivery request unit sending an article delivery request to a delivery company server corresponding to a selected delivery person and a local logistics depot server corresponding to the destination so that the selected delivery person delivers the article to the destination when any one of the plurality of delivery persons is selected.

11. The apparatus of claim 10, wherein:
when the user terminal accesses the shopping mall website and inputs the information of the destination by which the article is to be received in a purchase process for the purchase of the article, the shopping mall website sends the input information of the destination to the parcel delivery service operation server, and
the delivery information acquisition unit receives the information of the destination received from the shopping mall website.

12. The apparatus of claim 10, wherein the information extraction unit questions a plurality of delivery company servers associated with the plurality of delivery persons about the information of the plurality of delivery persons corresponding to the information of the destination and receives the information of the plurality of delivery persons corresponding to the information of the destination from the plurality of delivery company servers.

13. The apparatus of claim 10, further comprising a database server unit constructing a delivery person information database in which information of a plurality of delivery persons corresponding to information of a plurality of destinations is stored and managed based on interlocking with a plurality of delivery company servers,
wherein the information extraction unit extracts the information of the plurality of delivery persons corresponding to the information of the destination from the delivery person information database.

14. The apparatus of claim 10, wherein the information display unit transfers the information of the plurality of delivery persons to the shopping mall website and controls the shopping mall website so that a delivery person selection user interface comprising the information of the plurality of delivery persons is displayed in the user terminal in a purchase process for the purchase of the article.

15. The apparatus of claim 14, wherein the delivery person selection user interface comprises at least one of ID information of each of the delivery persons, evaluation information of each of the delivery persons and delivery company information corresponding to each of the delivery persons, and provides a function which enables the user terminal to select any one of the plurality of delivery persons.

16. The apparatus of claim 10, wherein the article delivery request comprises:
article information related to the article;
the information of the destination;
information of the selected delivery person;
information of the delivery company corresponding to the selected delivery person; and
information of a local logistics depot corresponding to the destination.

17. The apparatus of claim 10, wherein the information display unit displays an evaluation input user interface in which an evaluation of the delivery person who has sent the article is capable of being input using the shopping mall website in the user terminal and stores input evaluation information in a database in association with the information of the delivery person when the evaluation information about the delivery person is received through the evaluation input user interface.

18. The apparatus of claim 10, further comprising a contract conclusion unit making a transportation contract for a parcel delivery service with the shopping mall website, a plurality of delivery company servers and the local logistics depot server.

19. An integrated parcel delivery service system, comprising:
a shopping mall website in which an accessed user terminal is callable of purchasing an article;
a plurality of delivery company servers;
a plurality of local logistics depot servers; and
a parcel delivery service operation server operating in conjunction with the shopping mall website and the plurality of delivery company servers, obtaining information of a destination to which the article is to be delivered from the shopping mall website, extracting information of a plurality of delivery persons corresponding to the information of the destination, displaying the information of the plurality of delivery persons in the user terminal using the shopping mall website, and sending an article delivery request to a delivery company server corresponding to a selected delivery person and a local logistics depot server corresponding to the destination so that the selected delivery person delivers the article to the destination when any one of the plurality of delivery persons is selected.

20. A method of processing article delivery, comprising steps of:
inputting information of a destination to which an article is to be delivered in a purchase process for purchasing the article selected by a user terminal;
sending the input information of the destination to a parcel delivery service operation server;
receiving information of the plurality of delivery persons corresponding to the information of the destination from the parcel delivery service operation server;
displaying a delivery person selection user interface in which the received information of the plurality of delivery persons is included and any one of the piece of information of the plurality of delivery persons is capable of being selected in the user terminal; and
sending an article delivery request comprising information of a selected delivery person and article delivery information necessary to deliver the article to the parcel delivery service operation server when the delivery person is selected by the user terminal based on the delivery person selection user interface.
